(19) United States
(12) Patent Application Publication
(10) Pub. No.: US 2025/0333246 A1
(43) Pub. Date: Oct. 30, 2025

(54) CONVEYOR STOPPER AND MOVING CONVEYOR

(71) Applicant: LG ELECTRONICS INC., Seoul (KR)

(72) Inventors: Byungyoon MOON, Seoul (KR); Seongsang YUN, Seoul (KR); Jeonghun KIM, Seoul (KR); Hyunwook SHON, Seoul (KR)

(73) Assignee: LG ELECTRONICS INC., Seoul (KR)

(21) Appl. No.: 18/867,325

(22) PCT Filed: Jun. 3, 2022
(86) PCT No.: PCT/KR2022/007920

§ 371 Date: Nov. 19, 2024

(51) Int. Cl. B65G 13/07; B65G 13/075; B65G 41/00; B65G 47/66

(52) U.S. Cl. CPC B65G 13/07; B65G 13/075; B65G 41/006; B65G 47/66; B65G 2203/0266; B65G 2203/041

(57) ABSTRACT

This conveyor stopper comprises: a stopper module hinged to at least one of an inlet and an outlet of a conveyor around a first shaft; and an actuator which is coupled to the stopper module and switches the stopper module to a bridge mode or a stopper mode, wherein the stopper module comprises: a stopper housing on one side of which the first shaft is located; and a second shaft which is located in the stopper housing and spaced apart from the first shaft and to which the actuator is coupled, wherein, in the bridge mode, the upper surface of the stopper module forms a continuous surface with the upper surface of the conveyor, and in the stopper mode, the upper surface of the stopper module forms a surface that is bent at an angle greater than or equal to a predetermined angle from the upper surface of the conveyor. The conveyor stopper may act as a bridge so that objects to be moved can be easily transferred or loaded despite a step due to height difference, or a predetermined separation distance, between conveyors, or may act as a stopper so that objects to be moved do not fall even when the conveyor malfunctions.

### TECHNICAL FIELD

The present disclosure relates to a conveyor stopper coupled to a conveyor to form a bridge mode or a stopper mode and a conveyor mounted on a mobile body.

### BACKGROUND ART

In various industrial sites and the like, a conveyor is used to allow various moving objects such as components, finished products, and the like to be moved to a prescribed position. In the conveyor for performing this function, a multitude of rollers are arranged in a row and rotated in the same direction so that a moving object moves to a prescribed position by the rotation of the rollers.

On the other hand, there may be a height step difference when the transfer or loading of a moving object between one conveyor and another conveyor is performed. In this case, there is a problem that the transfer or loading of the moving object is possible only in a state in which the height between the conveyors is the same by using an additional driving source such as a lift.

In addition, when there is a separation distance between one conveyor and another conveyor, there is a risk that a moving object falls during the transfer or loading of the moving object.

Moreover, in general, a stopper means in the form of a cylinder using pneumatic pressure or the like is provided to stop a moving object on a conveyor. However, since such a stopper means is vertically installed in a moving direction of the moving object on the conveyor, it directly strikes the cylinder due to a transverse load generated when colliding with the moving object, thereby causing a problem of deteriorating the durability of the cylinder.

### DISCLOSURE

### Technical Tasks

One object of the present disclosure is to provide a conveyor stopper, and more particularly, a conveyor stopper which serves as a bridge to facilitate the transfer or loading of a moving object despite the presence of a height step difference or a prescribed separation distance between conveyors and also serves as a stopper to prevent the moving object from falling even despite conveyor malfunctions.

Another object of the present disclosure is to provide a moving conveyor in which a conveyor to which a conveyor stopper is coupled is mounted on a mobile body and the conveyor stopper is controlled by a controller installed in the mobile body.

### Technical Solutions

In one technical aspect of the present disclosure, provided is a conveyor stopper, including a stopper module hinge-coupled to at least one side of an entrance or an exit of a conveyor around a first shaft and an actuator coupled to the stopper module to switch the stopper module to a bridge mode or a stopper mode, wherein the stopper module may include a stopper housing having the first shaft positioned on one side thereof and a second shaft positioned in the stopper housing by being spaced apart from the first shaft and coupled to the actuator, wherein in the bridge mode, an upper surface of the stopper module may form a continuous surface with an upper surface of the conveyor, and wherein in the stopper mode, the upper surface of the stopper module may form a surface bent at an angle greater than or equal to a prescribed angle with respect to the upper surface of the conveyor.

The conveyor stopper may include a first guide roller rotatably coupled using the first shaft as an axis, wherein an upper surface of the first guide roller corresponds to an upper surface height of the conveyor.

The conveyor stopper may further include at least one second guide roller disposed side by side with the first guide roller in a length direction of the conveyor, and the first guide roller and the second guide roller may form the upper surface of the stopper module.

The conveyor stopper may include a guide belt connecting to synchronize the first guide roller and the second guide roller.

The conveyor stopper may include a driving belt connecting the first guide roller and an outermost roller of the conveyor.

The stopper housing may include a pair of side plates positioned on both sides of the first shaft and a pair of middle plates positioned between a pair of the side plates to have both end portions of the second shaft coupled thereto, and a length of the second shaft may be shorter than that of the first shaft.

A first guide roller rotatably coupled using the first shaft as an axis may be disposed between the side plate and the middle plate.

The conveyor stopper may further include at least one second guide roller disposed between the side plate and the middle plate side by side with the first guide roller in a length direction of the conveyor, and the first guide roller and the second guide roller may form the upper surface of the stopper module.

In another technical aspect of the present disclosure, provided is a moving conveyer, including a conveyor having a plurality of rollers, a conveyor stopper having a stopper module rotatably coupled to at least one of an entrance or an exit of the conveyor and an actuator coupled to the stopper module, a mobile body having the conveyor mounted thereon, and a controller installed in the mobile body to rotate the conveyor stopper, wherein the controller may control the conveyor stopper to switch to a bridge mode of forming a continuous surface with an upper surface of the conveyor by an upper surface of the stopper module or a stopper mode of forming a surface bent at an angle greater than or equal to a prescribed angle with the upper surface of the conveyor by the upper surface of the stopper module.

The moving conveyor may include a camera installed in the mobile body to capture an image in a traveling front of the mobile body and a sensor unit installed in the mobile body to detect a separation distance and a height difference between the conveyor and an external conveyor, and the controller may be configured to receive data generated from detecting the separation distance and the height difference between the conveyor and the external conveyor by the sensor unit through the image captured by the camera and control the conveyor stopper to switch to the bridge mode or the stopper mode according to the received data.

The conveyor stopper may include a first conveyor stopper coupled to the entrance of the conveyor and a second conveyor stopper coupled to the exit, and the conveyor stopper selected from the first conveyor stopper or the second conveyor stopper, being closer to the external conveyor than the external conveyor, may be switched to the bridge mode.

The conveyor stopper selected from the first conveyor stopper or the second conveyor stopper, having a longer separation distance from the external conveyor, may be switched to the stopper mode.

The stopper module may include a stopper housing having a first shaft disposed at one side thereof and a second shaft positioned in the stopper housing by being spaced apart from the first shaft and coupled to the actuator.

The moving conveyor may include a first guide roller rotatably coupled using the first shaft as an axis, and an upper surface of the first guide roller may correspond to an upper surface height of the conveyor.

The moving conveyor may further include at least one second guide roller disposed side by side with the first guide roller in a length direction of the conveyor, and the first guide roller and the second guide roller may form the upper surface of the stopper module.

The stopper housing may include a pair of side plates positioned on both sides of the first shaft and a pair of middle plates positioned between a pair of the side plates and having both end portions of the second shaft coupled thereto, and a length of the second shaft may be shorter than that of the first shaft.

A first guide roller rotatably coupled using the first shaft as an axis may be disposed between the side plate and the middle plate.

The moving conveyor may further include at least one second guide roller disposed between the side plate and the middle plate side by side with the first guide roller in a length direction of the conveyor, and the first guide roller and the second guide roller may form the upper surface of the stopper module.

The moving conveyor may include a first fixing bracket positioned between a pair of the middle plates and coupled to the first shaft and a second fixing bracket coupled to the actuator, and the first fixing bracket and the second fixing bracket may be coupled to the conveyor or the mobile body.

The stopper module may rotate with respect to the first fixing bracket using the first shaft as an axis.

### Advantageous Effects

A conveyor stopper according to the present disclosure may be switched from a bridge mode or a stopper mode by a stopper module rotatably coupled to at least one of an entrance or an exit of the conveyor and an actuator coupled to the stopper module.

When the conveyor stopper is switched to the bridge mode, the transfer or loading of the moving object may be facilitated even though there is a height difference or a prescribed separation distance between the conveyors.

In addition, when the conveyor stopper is switched to the stopper mode, the moving object may not fall even when the conveyor malfunctions, and a transverse load generated from collision with the moving object may be applied in an axial direction of the actuator to improve durability.

In addition, in a moving conveyor according to the present disclosure, a conveyor having a conveyor stopper coupled thereto is mounted on a mobile body and the conveyor stopper may be switched to a bridge mode or a stopper mode by a controller installed in the mobile body.

Further scope of applicability of the present disclosure will become apparent from the following detailed description. However, since various changes and modifications within the spirit and scope of the present disclosure can be clearly understood by those skilled in the art, specific embodiments such as the detailed description and the preferred embodiments of the present disclosure should be understood to be given by way of illustration only.

### DESCRIPTION OF DRAWINGS

FIG. 1 is a perspective diagram illustrating a conveyor stopper of the present disclosure.

FIG. 2 is a side view diagram illustrating a conveyor stopper according to an embodiment of the present disclosure.

FIG. 3 is a diagram illustrating a bridge mode of a conveyor stopper according to an embodiment of the present disclosure.

FIG. 4 is a diagram illustrating a stopper mode of a conveyor stopper according to an embodiment of the present disclosure.

FIG. 5 is a diagram illustrating a first guide roller coupled to a conveyor stopper according to an embodiment of the present disclosure.

FIG. 6 is a diagram illustrating a second guide roller included in a conveyor stopper according to an embodiment of the present disclosure.

FIG. 7 is a diagram illustrating a guide belt or a driving belt coupled to a stopper module of a conveyor stopper according to an embodiment of the present disclosure.

FIG. 8 is a diagram illustrating a conveyor stopper having a second shaft is coupled to a middle plate according to an embodiment of the present disclosure.

FIG. 9 is a diagram illustrating a conveyor stopper having a first guide roller coupled thereto according to an embodiment of the present disclosure.

FIG. 10 is a diagram illustrating a conveyor stopper including a second guide roller according to an embodiment of the present disclosure.

FIG. 11 is a diagram illustrating a moving conveyor in which a conveyor having a conveyor stopper coupled thereto is mounted on a mobile body according to an embodiment of the present disclosure.

FIG. 12 is a block diagram illustrating a configuration of a camera, a sensor unit, and a controller coupled to a mobile body of the present disclosure.

FIG. 13 is a diagram illustrating a process of moving a moving object between a conveyor and an external conveyor in a bridge mode of a conveyor stopper according to an embodiment of the present disclosure.

FIG. 14 is a diagram illustrating another embodiment in which a moving object moves between a conveyor and an external conveyor in a bridge mode of a conveyor stopper of the present disclosure.

FIG. 15 is a diagram illustrating a conveyor in which a bridge mode and a stopper mode of a conveyor stopper are formed according to an embodiment of the present disclosure.

FIG. 16 is a diagram illustrating first and second fixing brackets coupled to a conveyor stopper according to an embodiment of the present disclosure.

### BEST MODE

Description will now be given in detail according to exemplary embodiments disclosed herein, with reference to the accompanying drawings. The same or equivalent components may be provided with the same reference numbers, and description thereof will not be repeated. As used herein, the suffixes “module” and “part” are added or used interchangeably to facilitate preparation of this specification and are not intended to suggest distinct meanings or functions. In describing embodiments disclosed in this specification, relevant well-known technologies may not be described in detail in order not to obscure the subject matter of the embodiments disclosed in this specification. In addition, it should be noted that the accompanying drawings are only for easy understanding of the embodiments disclosed in the present specification, and should not be construed as limiting the technical spirit disclosed in the present specification. As such, the present disclosure should be construed to extend to any alterations, equivalents and substitutes in addition to those which are particularly set out in the accompanying drawings.

Although the terms first, second, etc. may be used herein to describe various elements, these elements should not be limited by these terms. These terms are generally only used to distinguish one element from another.

It will be understood that when an element is referred to as being “connected with” another element, the element can be directly connected with the other element or intervening elements may also be present. In contrast, it will be understood that when an element is referred to as being “directly connected with” another element, there are no intervening elements present.

A singular representation may include a plural representation unless it represents a definitely different meaning from the context.

The terms such as “include” or “have” used herein are intended to indicate that features, numbers, steps, operations, elements, components, or combinations thereof used in the following description exist and it should be thus understood that the possibility of existence or addition of one or more different features, numbers, steps, operations, elements, components, or combinations thereof is not excluded.

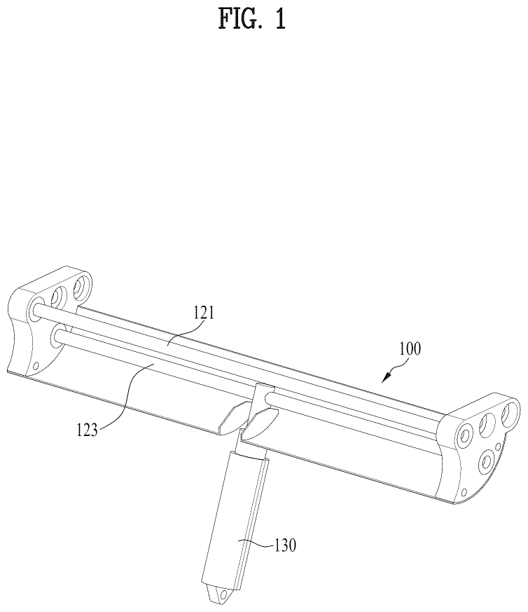

FIG. 1 is a perspective diagram illustrating a conveyor stopper of the present disclosure.

A conveyor stopper 100 of the present disclosure includes a stopper module 120 and an actuator 130. The stopper module 120 includes a first shaft 121, a second shaft 123, and a stopper housing 125.

The stopper module 120 is hinge-coupled to at least one side of an entrance or an exit of a conveyor 110 around the first shaft 121, the first shaft 121 is positioned at one side of the stopper housing 125, and the second shaft 123 is positioned at the stopper housing 125 while being spaced apart from the first shaft 121.

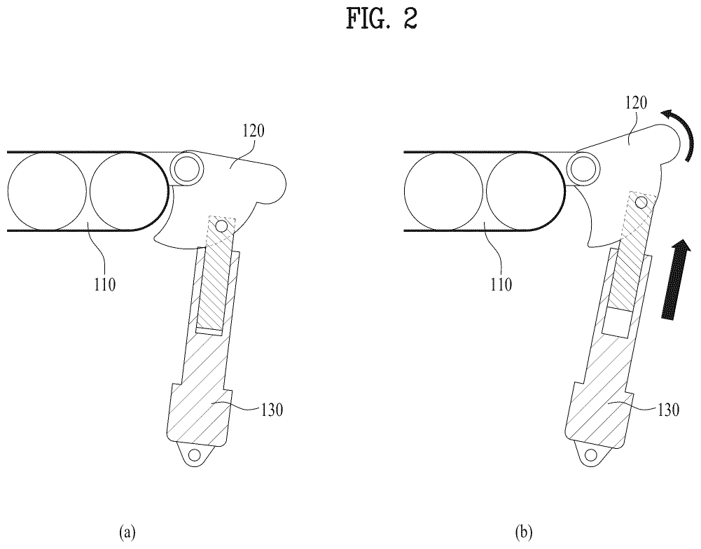

FIG. 2 is a side view diagram illustrating a conveyor stopper according to an embodiment of the present disclosure.

An actuator 130 may be coupled to a second shaft 123 to vary in length, and the stopper module 120 may rotate about the first shaft 121 according to a change in the length of the actuator 130 so that a conveyor stopper 100 may switch to a bridge mode or a stopper mode.

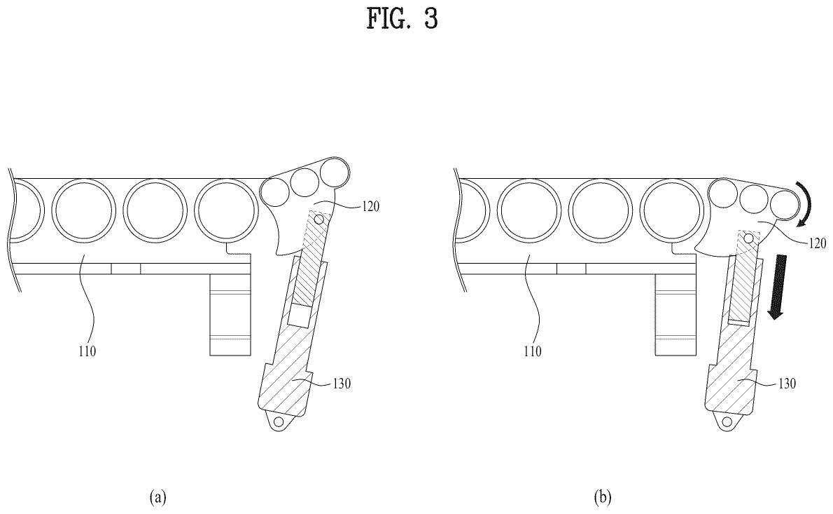

FIG. 3 is a diagram illustrating a bridge mode of a conveyor stopper according to an embodiment of the present disclosure.

In a bridge mode, an upper surface of a stopper module 120 may form a continuous surface with an upper surface of a conveyor 110. Accordingly, in a bridge mode, various moving objects moved by the conveyor 110 may smoothly move to a transfer position or a loading position.

FIG. 3 (a) illustrates an embodiment in which a stopper module 120 rotates to form a bridge mode when the height of the transfer or loading position of a moving object is higher than that of a conveyor 110.

FIG. 3 (b) illustrates another embodiment in which a stopper module 120 rotates to form a bridge mode when the height of the transfer or loading position of a moving object is lower than that of a conveyor 110.

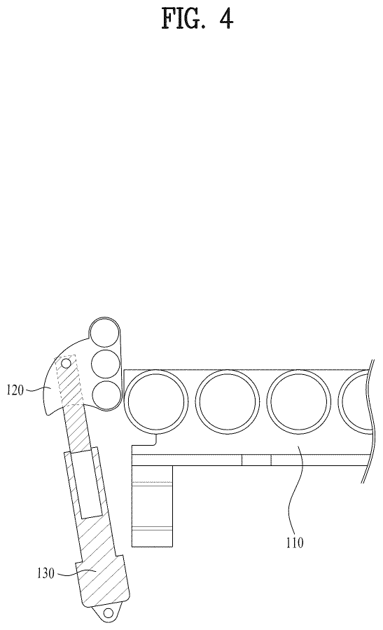

FIG. 4 is a diagram illustrating a stopper mode of a conveyor stopper according to an embodiment of the present disclosure.

In a stopper mode, an upper surface of a stopper module 120 may form a surface that is bent at an angle greater than or equal to a prescribed angle with respect to an upper surface of a conveyor 110. Accordingly, in the stopper mode, various moving objects moved by the conveyor 110 may be stopped. Accordingly, it is possible to prevent a moving object from falling due to the malfunction of the conveyor 110 in the process of transferring or loading the moving object.

In a stopper mode, a length of an actuator 130 is longer than that of the actuator 130 in a bridge mode. Accordingly, in the bridge mode, an angle formed by an upper surface of a stopper module 120 and an upper surface of the conveyor 110 in the stopper mode is greater than an angle between the upper surface of the stopper module 120 and the upper surface of the conveyor 110. In the stopper mode, it is preferable that the angle between the upper surface of the stopper module 120 and the upper surface of the conveyor 110 is 45 degrees or more.

Meanwhile, in the stopper mode, a transverse load generated from colliding with a moving object is applied in an axial direction of an actuator 130, and thus, a conveyor stopper 100 may have a stopper function and improved durability.

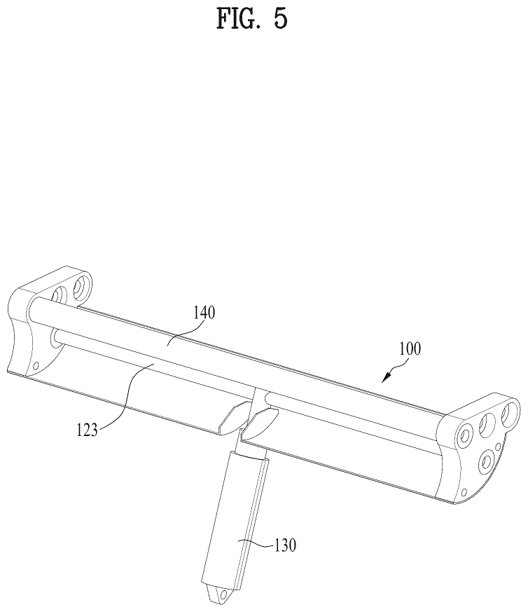

FIG. 5 is a diagram illustrating a first guide roller coupled to a conveyor stopper according to an embodiment of the present disclosure.

A first guide roller 140 is rotatably coupled using a first shaft 121 as an axis, and an upper surface of the first guide roller 140 corresponds to a height of an upper surface of a conveyor 110. Accordingly, the transfer or loading of various moving objects moved by the conveyor 110 in a bridge mode may be smoothly performed. In addition, the moving object may be stopped in a stopper mode.

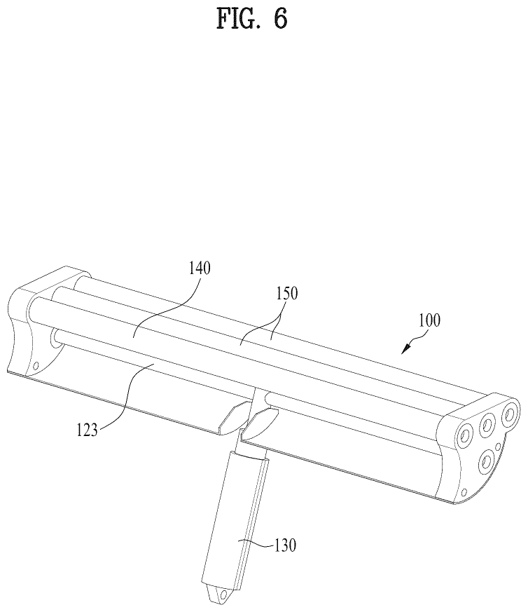

FIG. 6 is a diagram illustrating a second guide roller included in a conveyor stopper according to an embodiment of the present disclosure.

At least one second guide roller 150 may be disposed side by side with a first guide roller 140 in a length direction of a conveyor 110. In addition, the first guide roller 140 and the second guide roller 150 constitute an upper surface of a stopper module 120. Accordingly, the transfer or loading of various moving objects moved by the conveyor 110 may be smoothly performed in a bridge mode, and the moving object may be stopped in a stopper mode.

When a second guide roller 150 is disposed, the second guide roller 150 may be facilitated to rotate through a bearing coupling with a stopper housing 125.

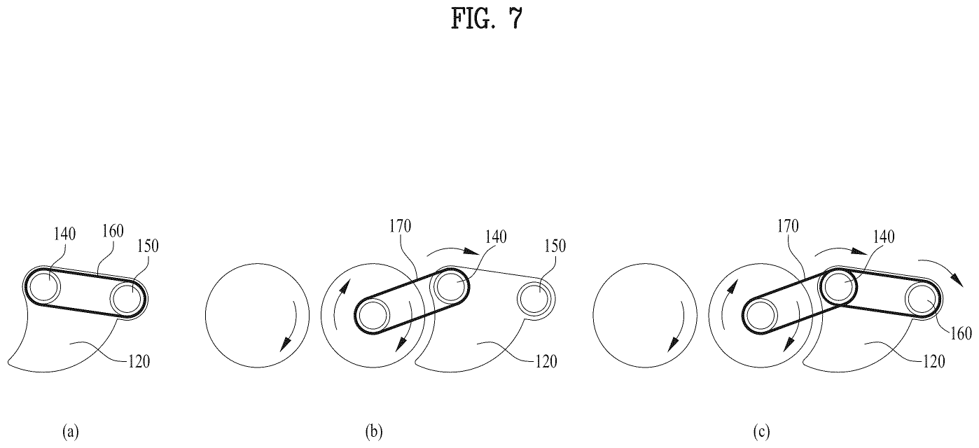

FIG. 7 is a diagram illustrating a guide belt or a driving belt coupled to a stopper module of a conveyor stopper according to an embodiment of the present disclosure.

FIG. 7 (a) illustrates an embodiment provided with a guide belt 160 for connecting and synchronizing a first guide roller 140 and a second guide roller 150.

Since the guide belt 160 is provided, a flat surface having no curvature may be formed between the first guide roller 140 and the second guide roller 150. Accordingly, the transfer or loading of various moving objects moved by a conveyor 110 in a bridge mode may be smoothly performed, and the moving object may be stopped in a stopper mode.

FIG. 7 (b) illustrates an embodiment provided with a driving belt 170 connecting a first guide roller 140 and an outermost roller of a conveyor 110.

Since the driving belt 170 is provided to rotate a first guide roller 140 in the same direction as a rotation direction of a roller of the conveyor 110, the transfer or loading of various moving objects moved by the conveyor 110 in a bridge mode may be more smoothly performed.

FIG. 7 (c) illustrates an embodiment in which a guide belt 160 and a driving belt 170 are simultaneously provided.

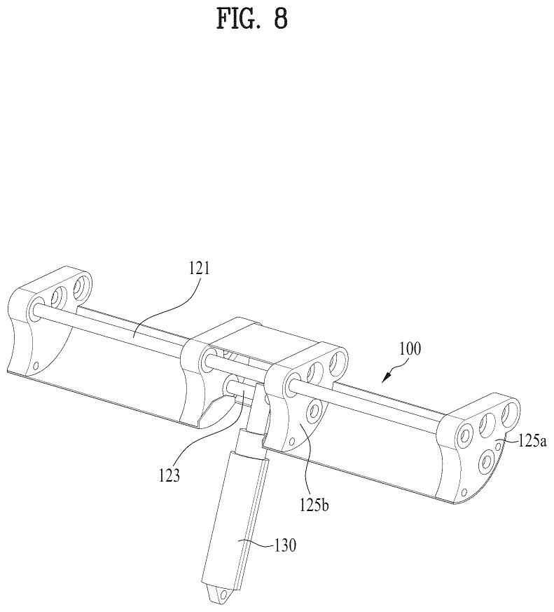

FIG. 8 is a diagram illustrating a conveyor stopper in which a second shaft is coupled to a middle plate according to an embodiment of the present disclosure.

An actuator 130 is coupled to a second shaft 123 and is driven to rotate a stopper module 120. When it is necessary to prevent the second shaft 123 from being bent, it is necessary to minimize the length of the second shaft 123.

In this case, a stopper housing 125 may include a side plate 125a positioned at both sides of a first shaft 121 and a pair of middle plates 125b positioned between a pair of the side plates 125a and coupled to both end portions of the second shaft 123, and the length of the second shaft 123 may be formed shorter than the length of the first shaft 121.

Accordingly, when the actuator 130 coupled to the second shaft 123 is driven, a stopper module 120 may be rotated while minimizing the bending effect of the second shaft 123.

In addition, a planar member connecting upper portions of a pair of the middle plates 125b may be included. Accordingly, when the stopper module 120 rotates to enable a conveyor stopper 100 to form a bridge mode or a stopper mode, all the components of the stopper module 120 may rotate at the same angle so that the transfer or loading or stopping of various moving objects moved by the conveyor 110 may be smoothly performed.

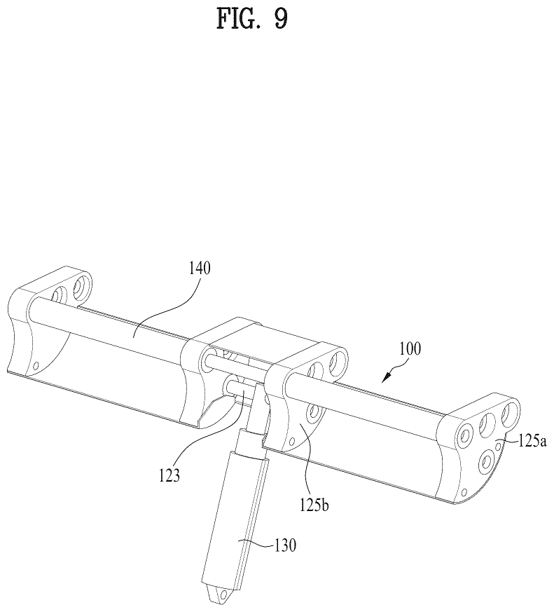

FIG. 9 is a diagram illustrating a conveyor stopper having a first guide roller coupled thereto according to an embodiment of the present disclosure is coupled.

A first guide roller 140 is coupled between a side plate 125a and a middle plate 125b so as to be rotatable about a first shaft 121, and an upper surface of the first guide roller 140 corresponds to a height of an upper surface of a conveyor 110. Accordingly, the transfer or loading of various moving objects moved by the conveyor 110 in a bridge mode may be smoothly performed, and the moving object may be stopped in a stopper mode.

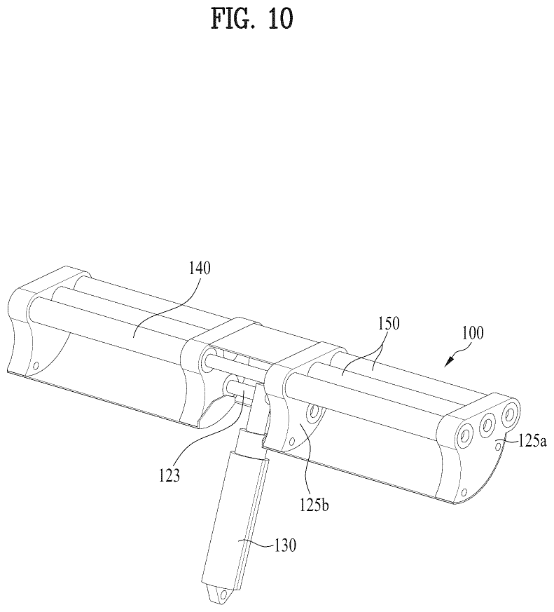

FIG. 10 is a diagram illustrating a conveyor stopper including a second guide roller according to an embodiment of the present disclosure.

At least one second guide roller 150 may be disposed side by side with a first guide roller 140 between a side plate 125 a and a middle plate 125b in a length direction of a conveyor 110. In addition, the first guide roller 140 and the second guide roller 150 constitute an upper surface of a stopper module 120. Accordingly, the transfer or loading of various moving objects moved by the conveyor 110 in a bridge mode may be smoothly performed, and the moving object may be stopped in a stopper mode.

When the second guide roller 150 is disposed, the second guide roller 150 may be facilitated to rotate through the bearing coupling with the side plate 345a and the middle plate 345b.

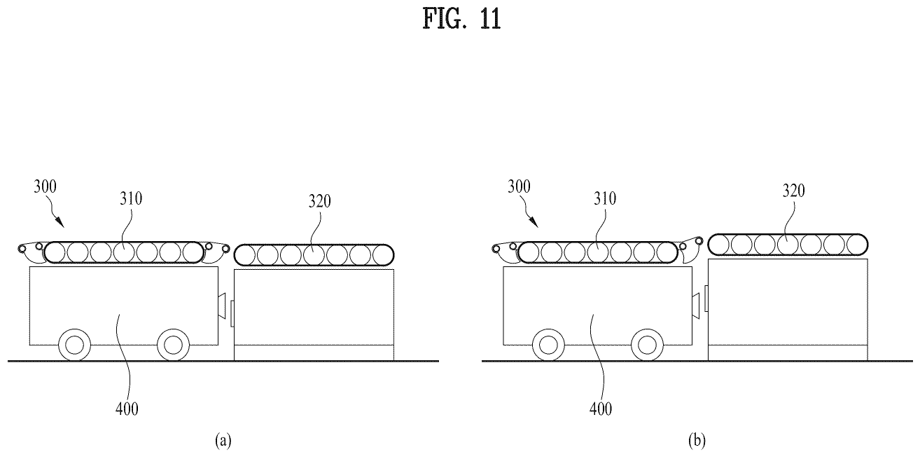

FIG. 11 is a diagram illustrating a moving conveyor in which a conveyor having a conveyor stopper coupled thereto is mounted on a mobile body according to an embodiment of the present disclosure.

A moving conveyor 300 of the present disclosure includes a conveyor 310 including a plurality of rollers, a conveyor stopper 330, a mobile body 400, and a controller 410.

The conveyor stopper 330 includes a stopper module 340 rotatably coupled to at least one of an entrance or an exit of the conveyor 310 and an actuator 350 coupled to the stopper module 340 to vary in length.

The conveyor 310 is mounted on the mobile body 400, and the controller 410 is installed on the mobile body 400 to rotate the conveyor stopper 330.

The moving conveyor 300 may move to an external conveyor 320 by the mobile body 400. In addition, the mobile body 400 may include a mobile robot in the form of an Automatic Guided Vehicle (AGV)-type mobile robot or an Autonomous Mobile Robot (AMR)-type mobile robot.

The controller 410 may control the conveyor stopper 330 to switch to a bridge mode in which an upper surface of the stopper module 340 forms a continuous surface with an upper surface of the conveyor 310 or a stopper mode in which the upper surface of the stopper module 340 forms a surface at an angle greater than or equal to a prescribed angle with the upper surface of the conveyor 310.

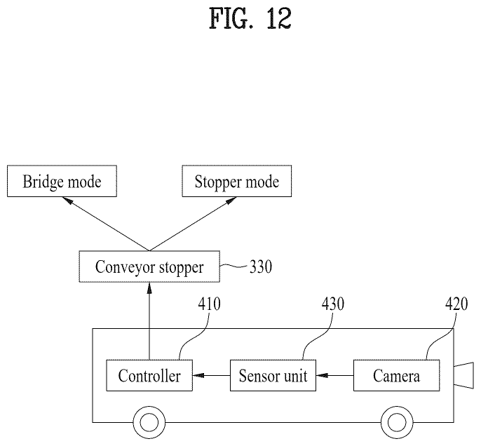

FIG. 12 is a block diagram illustrating a configuration of a camera, a sensor unit, and a controller coupled to a mobile body of the present disclosure.

A camera 420 installed in a mobile body 400 captures an image in front of the mobile body 400, and a sensor unit 430 installed in the mobile body 400 detects a separation distance and a height difference between a conveyor 310 and an external conveyor 320. In addition, a controller 410 installed in the mobile body 400 may receive data generated from detecting the separation distance and the height difference between the conveyor 310 and the external conveyor 320 by the sensor unit 430 through the image captured by the camera 420 and control a conveyor stopper 330 in a bridge mode or a stopper mode according to the received data.

Accordingly, even if the height difference between the conveyor 310 and each of several external conveyors 320 is different, the moving conveyor 300 of the present disclosure may control the conveyor stopper 330 through the camera 420, the sensor unit 430, and the controller 410 installed in the mobile body 400 to rotate the stopper module 340 according to the height difference, thereby facilitating various moving objects, which are moved by the conveyor 310 and the several external conveyors 320, to be moved.

In addition, even if there is a separation distance between the conveyor 310 and the external conveyor 320, the moving object may smoothly move through the conveyor stopper 330, thereby reducing working time through efficient movement of the mobile body 400.

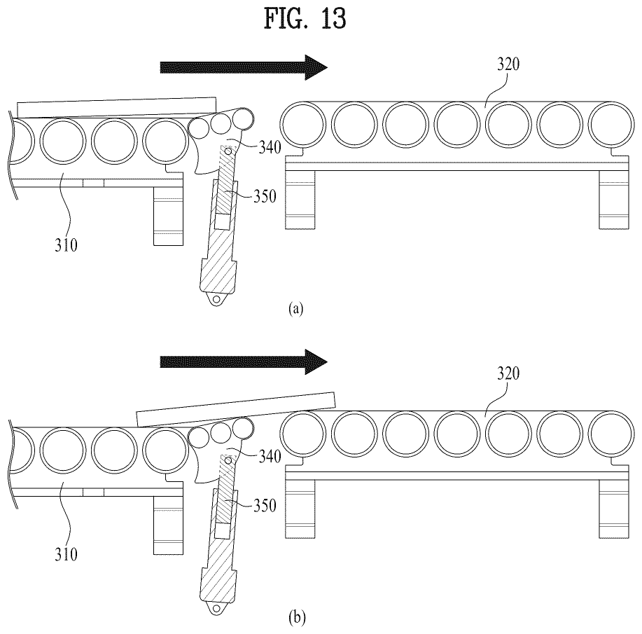

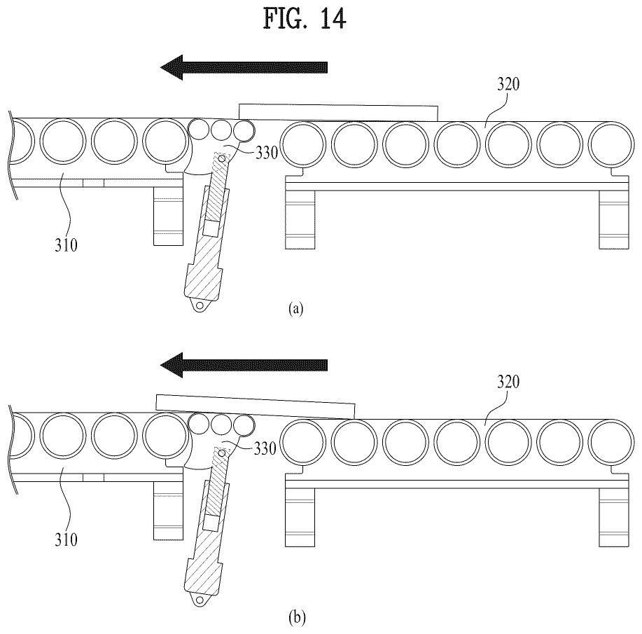

FIG. 13 is a diagram illustrating a process of moving a moving object between a conveyor and an external conveyor in a bridge mode of a conveyor stopper according to an embodiment of the present disclosure. FIG. 14 is a diagram illustrating another embodiment in which a moving object moves between a conveyor and an external conveyor in a bridge mode of a conveyor stopper of the present disclosure.

As a mobile body 400 moves to an external conveyor 320, a conveyor stopper 330 is switched to a bridge mode by a controller 410 according to a separation distance and a height difference between a conveyor 310 and the external conveyor 320. In this case, various moving objects moved by the conveyor 310 and the external conveyor 320 may be smoothly moved.

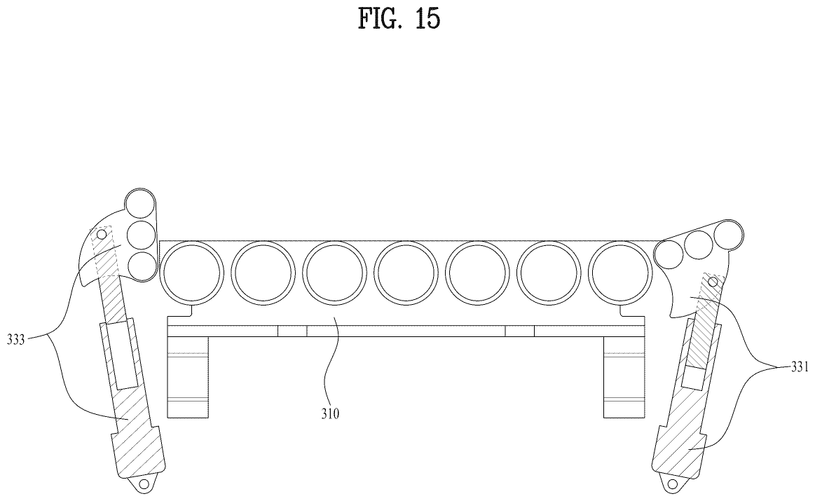

FIG. 15 is a diagram illustrating a conveyor in which a bridge mode and a stopper mode of a conveyor stopper are formed according to an embodiment of the present disclosure.

According to an embodiment of the present disclosure, a conveyor stopper 330 may include a first conveyor stopper 331 coupled to an entrance of a conveyor 310 and a second conveyor stopper 333 coupled to an exit of the conveyor 310.

The first conveyor stopper 331 and the second conveyor stopper 333 are individually driven by a controller 410.

Either the first conveyor stopper 331 or the second conveyor stopper 333, which is closer to the outer conveyor 320, of the conveyor stopper 330, may be switched to a bridge mode.

In addition, either the first conveyor stopper 331 or the second conveyor stopper 333, which has a longer separation distance from the external conveyor 320, of the conveyor stopper 330, may be switched to a stopper mode.

When the conveyor stopper 330 is coupled to both sides of an entrance and an exit of the conveyor 310 to differ in mode, a moving object may smoothly move despite a separation distance and a height difference between the conveyor 310 and the external conveyor 320, and at the same time, the moving object may be prevented from falling due to the malfunction of the conveyor 310 in the process of transferring or loading the moving object.

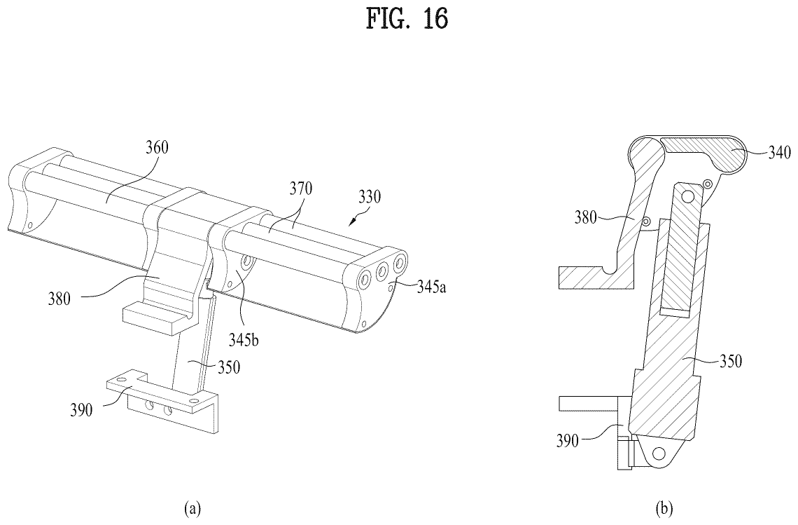

FIG. 16 is a diagram illustrating that a first fixing bracket and a second fixing bracket are coupled to a conveyor stopper according to an embodiment of the present disclosure.

According to an embodiment of the present disclosure, a stopper housing 345 includes a pair of side plates 345a positioned on both sides of a first shaft 341 and a pair of middle plates 345b positioned between a pair of the side plates 345 an and having both end portions of a second shaft 343 coupled thereto. An actuator 350 is rotatably coupled to the second shaft 343. In this case, a first fixing bracket 380 is positioned between a pair of the middle plates 345b and coupled to the first shaft 341. And, a second fixing bracket 390 is coupled to the actuator 350.

The first fixing bracket 380 and the second fixing bracket 390 may be coupled to a conveyor 310 or a mobile body 400. A stopper module 340 rotates with respect to the first fixing bracket 380 about the first shaft 341 according to a change in the length of the actuator 350.

When the first fixing bracket 380 and the second fixing bracket 390 are coupled to the conveyor 310 or the mobile body 400, a conveyor stopper 330 may be more easily coupled to the conveyor 310 than the case in which the stopper module 340 is hinge-coupled to an entrance or an exit of the conveyor 310 about the first shaft 341 according to another embodiment of the present disclosure.

The above detailed description is to be construed in all aspects as illustrative and not restrictive. The scope of the present disclosure should be determined by reasonable interpretation of the appended claims and all changes coming within the equivalency range of the present disclosure are intended to be embraced in the scope of the present disclosure.

1. A conveyor stopper, comprising:
a stopper module hinge-coupled to at least one side of an entrance or an exit of a conveyor around a first shaft; and
an actuator coupled to the stopper module to switch the stopper module to a bridge mode or a stopper mode,
wherein the stopper module comprises a stopper housing having the first shaft positioned on one side thereof and a second shaft positioned in the stopper housing by being spaced apart from the first shaft and coupled to the actuator,
wherein in the bridge mode, an upper surface of the stopper module forms a continuous surface with an upper surface of the conveyor, and
wherein in the stopper mode, the upper surface of the stopper module forms a surface bent at an angle greater than or equal to a prescribed angle with respect to the upper surface of the conveyor.

2. The conveyor stopper of claim 1, comprising a first guide roller rotatably coupled using the first shaft as an axis, wherein an upper surface of the first guide roller corresponds to an upper surface height of the conveyor.

3. The conveyor stopper of claim 2, further comprising at least one second guide roller disposed side by side with the first guide roller in a length direction of the conveyor, wherein the first guide roller and the second guide roller form the upper surface of the stopper module.

4. The conveyor stopper of claim 3, comprising a guide belt connecting to synchronize the first guide roller and the second guide roller.

5. The conveyor stopper of claim 3, comprising a driving belt connecting the first guide roller and an outermost roller of the conveyor.

6. The conveyor stopper of claim 1, the stopper housing comprising:
a pair of side plates positioned on both sides of the first shaft; and
a pair of middle plates positioned between a pair of the side plates to have both end portions of the second shaft coupled thereto,
wherein a length of the second shaft is shorter than that of the first shaft.

7. The conveyor stopper of claim 6, wherein a first guide roller rotatably coupled using the first shaft as an axis is disposed between the side plate and the middle plate.

8. The conveyor stopper of claim 7, further comprising at least one second guide roller disposed between the side plate and the middle plate side by side with the first guide roller in a length direction of the conveyor, wherein the first guide roller and the second guide roller form the upper surface of the stopper module.

9. A moving conveyer, comprising:
a conveyor having a plurality of rollers;
a conveyor stopper having a stopper module rotatably coupled to at least one of an entrance or an exit of the conveyor and an actuator coupled to the stopper module;
a mobile body having the conveyor mounted thereon; and
a controller installed in the mobile body to rotate the conveyor stopper,
wherein the controller controls the conveyor stopper to switch to a bridge mode of forming a continuous surface with an upper surface of the conveyor by an upper surface of the stopper module or a stopper mode of forming a surface bent at an angle greater than or equal to a prescribed angle with the upper surface of the conveyor by the upper surface of the stopper module.

10. The moving conveyor of claim 9, comprising:
a camera installed in the mobile body to capture an image in a traveling front of the mobile body; and
a sensor unit installed in the mobile body to detect a separation distance and a height difference between the conveyor and an external conveyor,
wherein the controller is configured to receive data generated from detecting the separation distance and the height difference between the conveyor and the external conveyor by the sensor unit through the image captured by the camera and control the conveyor stopper to switch to the bridge mode or the stopper mode according to the received data.

11. The moving conveyor of claim 10, wherein the conveyor stopper comprises a first conveyor stopper coupled to the entrance of the conveyor and a second conveyor stopper coupled to the exit and
wherein the conveyor stopper selected from the first conveyor stopper or the second conveyor stopper, being closer to the external conveyor than the external conveyor, is switched to the bridge mode.

12. The moving conveyor of claim 11, wherein the conveyor stopper selected from the first conveyor stopper or the second conveyor stopper, having a longer separation distance from the external conveyor, is switched to the stopper mode.

13. The moving conveyor of claim 10. the stopper module comprising:
a stopper housing having a first shaft disposed at one side thereof; and
a second shaft positioned in the stopper housing by being spaced apart from the first shaft and coupled to the actuator.

14. The moving conveyor of claim 13, comprising a first guide roller rotatably coupled using the first shaft as an axis, wherein an upper surface of the first guide roller corresponds to an upper surface height of the conveyor.

15. The moving conveyor of claim 14, further comprising at least one second guide roller disposed side by side with the first guide roller in a length direction of the conveyor, wherein the first guide roller and the second guide roller form the upper surface of the stopper module.

16. The moving conveyor of claim 13, the stopper housing comprising:
a pair of side plates positioned on both sides of the first shaft; and
a pair of middle plates positioned between a pair of the side plates and having both end portions of the second shaft coupled thereto,
wherein a length of the second shaft is shorter than that of the first shaft.

17. The moving conveyor of claim 16, wherein a first guide roller rotatably coupled using the first shaft as an axis is disposed between the side plate and the middle plate.

18. The moving conveyor of claim 17, further comprising at least one second guide roller disposed between the side plate and the middle plate side by side with the first guide roller in a length direction of the conveyor, wherein the first guide roller and the second guide roller form the upper surface of the stopper module.

19. The moving conveyor of claim 16, comprising;
a first fixing bracket positioned between a pair of the middle plates and coupled to the first shaft; and
a second fixing bracket coupled to the actuator,
wherein the first fixing bracket and the second fixing bracket are coupled to the conveyor or the mobile body.

20. The moving conveyor of claim 19, wherein the stopper module rotates with respect to the first fixing bracket using the first shaft as an axis.
